(19) United States
(12) Patent Application Publication
(10) Pub. No.: US 2007/0013486 A1
(43) Pub. Date: Jan. 18, 2007

(54) Radio frequency identification and communication device

(75) Inventors: Wooi Gan Yeoh, Singapore (SG); Wee Liang Lien, Singapore (SG); Yeung Bun Choi, Singapore (SG); Kok Yin Tham, Singapore (SG); Yi Song Li, Singapore (SG); Sheng Xi Diao, Singapore (SG)

Correspondence Address: STAAS & HALSEY LLP, SUITE 700, 1201 NEW YORK AVENUE, N.W., WASHINGTON, DC, 20005, US

(73) Assignees: TOPPAN PRINTING CO., LTD., Tokyo (JP); AGENCY FOR SCIENCE, TECHNOLOGY AND RESEARCH, Centros Way (SG)

(21) Appl. No.: 11/490,497

(22) Filed: Jul. 21, 2006

Related U.S. Application Data
(63) Continuation of application No. PCT/JP04/18424, filed on Dec. 3, 2004.

(30) Foreign Application Priority Data
Jan. 30, 2004 (SG) 200400496-6

(51) Int. Cl. H04Q 5/22

(52) U.S. Cl. 340/10.34; 340/572.1; 340/10.1

(57) ABSTRACT

A low-power, passive radio frequency identification and communication device communicable with a device reader is disclosed, comprising an RF front end for receiving from and transmitting to the device reader RF signals and extracting power and data from an RF signal generated by the device reader, a controller for receiving from and transmitting to the RF front end data, and a memory for receiving from and transmitting to the controller data. The memory is readable and writable by the controller and operable using first and second voltage supplies during read and write operations, respectively, the first and second voltage supplies being of different voltage supply levels.

### CROSS-REFERENCE TO RELATED APPLICATIONS

This is a Continuation Application of PCT Application No. PCT/JP2004/018424, filed Dec. 3, 2004, which was published under PCT Article 21(2) in English.

This application is based upon and claims the benefit of priority from prior Singapore Patent Application No. 200400496-6, filed Jan. 30, 2004, the entire contents of which are incorporated herein by reference.

### BACKGROUND OF THE INVENTION

1. Field of the Invention

The invention relates generally to communication devices. In particular, it relates to a radio frequency (RF) identification and communication device.

2. Description of the Related Art

A contactless or RF identification and communication (RFID) device, embodied in the form of a tag, transponder or card, is commonly used in numerous applications for identifying an object. These applications include sentry control, access control, inventory control, live stock tracking, vehicle telemetry, and etc.

For application efficacy, miniaturization of the RFID device is desirable since the device is typically tagged or attached to an object for identification of the object. A device reader identifies the device which bears identification information about the object through interrogation, which consists of contactless or RF-based communication between the device and the device reader. For achieving optimal miniaturization, passive devices are preferred than active devices, which are devices having internal power sources.

A passive device generates power from RF signals transmitted by the device reader for one-off or instant usage. Because such generated power is limited and cannot be stored for subsequent usage, it is therefore critical that the design of such a passive device is directed at achieving low-power internal operations.

To achieve low-power internal operations, passive devices are typically required to provide different operating voltage supplies with different voltage supply levels for powering different circuit blocks within these devices. Such passive devices are also typically required to provide different clock frequencies for operation of the different circuit blocks. General requirements for the passive devices include incorporating a read/write memory and communication capability with the device reader.

A number of conventional proposals are directed at RFID devices but do not address the need to provide both different operating voltage supplies and clock frequencies required for low-power operations in RFID devices.

In U.S. Pat. No. 6,104,290 to Naguleswaran, a contactless identification and communication system in which use of two oscillators in a transponder is proposed. The transponder operates at a higher speed during transmission operations for transmitting data to a device reader and at a lower speed during other operations. By doing this, power-saving operations are purportedly carried out. However, this proposal has a demerit of having two oscillators leading an enlargement of the device and an increase of a cost of the device.

In U.S. Pat. No. 6,211,786 to Yang et al., a battery-free circuit for an RFID tag is proposed for low-frequency application, and in U.S. Pat. No. 6,147,605 to Vega et al., a circuit for an electrostatic RFID device is proposed. Neither of these proposals is directed at multiple voltage supplies-multiple clock frequencies operations for power saving in the respective RFID devices.

There is therefore a need for a low-power, passive RFID device having different operating voltage supplies and clock frequencies for performing power-saving operations.

### BRIEF SUMMARY OF THE INVENTION

In accordance with one aspect of the invention, there is disclosed a radio frequency identification and communication device communicable with a device reader, comprising an RF front end for receiving from and transmitting to the device reader RF signals and extracting power and data from an RF signal generated by the device reader, a controller for receiving from and transmitting to the RF front end data, and a memory for receiving from and transmitting to the controller data. The memory is readable and writable by the controller and operable using first and second voltage supplies during read and write operations, respectively, the first and second voltage supplies being of different voltage supply levels.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram of an RFID device according to the embodiment of the invention;

FIG. 2 is a schematic diagram of an RF front end block in the RFID device of FIG. 1;

FIGS. 3A and 3B are timing diagrams illustrating encoded data decoded in a two-stage decoding process using a forward deduction scheme implemented in a digital block in the RFID device of FIG. 1;

FIGS. 4A and 4B are flowcharts of an implementation the decoding process of FIGS. 3A and 3B; and

FIG. 5 is a circuit diagram of a DC-DC converter in the RFID device of FIG. 1.

### DETAILED DESCRIPTION OF THE INVENTION

Embodiments of the invention are described hereinafter for addressing the need for a low-power, passive RFID device having different operating voltage supplies and clock frequencies for performing power-saving operations.

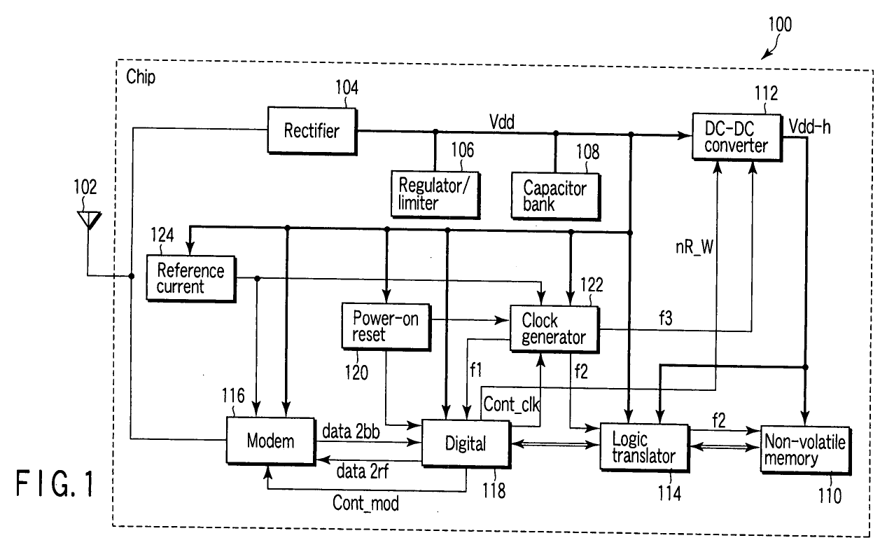

A low-power, passive RFID device 100 according to an embodiment of the invention is described hereinafter with reference to FIGS. 1 to 5. The RFID device 100 exemplifies one of many RFID devices typically used in conjunction with an RFID device reader to form an RFID system. Such an RFID system typically performs identification-based applications by firstly identifying the RFID devices in proximity through interrogation, which is a process consisting of the RFID reader broadcasting an interrogation signal and in response receiving signals from the RFID devices being interrogated bearing identification information relating to the object and other data.

The overall architecture of the RFID device 100 is described hereinafter with reference to FIG. 1, which is a block diagram depicting circuit blocks of the RFID device 100. Each circuit block is configured internally and vis-à-vis other blocks for passive, low-power operations and directed at facilitating optimal miniaturized implementation of the RFID device 100. The RFID device 100 may then be implemented as a chip, tag, or card as known to those skilled in the art. An RF frequency of a range of 300 MHz to 3 GHz is used in the embodiment.

In the RFID device 100, an antenna 102 receives interrogation or downlink signals generated and broadcasted by a RFID device reader (not shown), which are delivered to power generation blocks 104, 106, 108 for generating the required operating power from a carrier, for example a 2.45-GHz carrier, in the interrogation or downlink signals. The power generation blocks 104, 106, 108 include a rectifier 104, a regulator 106, and a capacitor bank 108.

In a passive device such as the RFID device 100, such blocks are critical to the operability of their host device because the generated operating power is supplied to all other circuit blocks in the RFID device 100. The level of voltage is proportional to the distance between the RFID device 100 and the device reader so that a very high voltage is generated to destroy some blocks of the RFID device 100 if the distance is very short. The rectifier 104 provides a rectified voltage and the regulator 106 maintains the rectified voltage below safe operating limits so that a generated operating voltage Vdd is typically kept low (˜1V) to minimize power consumption within the RFID device 100. The capacitor bank 108 provides temporary or short-term storage of the power generated by tapping the operating voltage Vdd. The operating voltage Vdd is used to power all circuit blocks, except a memory 110, which operates with higher operating voltage supplies.

A dc-dc converter 112 is connected to the output of the power generation blocks 104, 106, 108 for accepting the operating voltage Vdd and from that generates the higher operating voltage supplies for the memory 110 to perform memory operations. The dc-dc converter 112 outputs a higher voltage Vdd-h for read and write operations which through programming the voltage level is double- or triple-times that of the operating voltage Vdd, respectively. For the same reason, a logic translator 114 is also connected to the dc-dc converter 112 and used as an interface for bridging logic levels between other digital circuit blocks in the RFID device 100 and the memory 110. The logic translator 114 converts the logic level of data received from the memory 110 from Vdd-h (=2×Vdd, for example) to Vdd during read operations, and of data transmitted to the memory 110 from Vdd to Vdd-h (=3×Vdd, for example) during write operations. This allows other circuit blocks to operate with the lowest available operating voltage supply, ie Vdd, instead of the highest operating voltage so that the overall power consumption of the RFID device 100 is minimized.

A modem 116 is connected to the antenna 102 for demodulating downlink signals containing an incoming RF carrier with downlink data, hereinafter referred to as data2bb, and modulating the same incoming RF carrier with uplink data, hereinafter referred to as data2rf, into uplink signals. Preferably, communication protocol used includes OOK/ASK modulation and Manchester coding for downlink and uplink communication, whereas uplink communication is achieved by modulating the incoming RF carrier with data2rf through backscattering technique, which involves reflecting the incoming carrier by changing impedance.

A digital block 118 performs power management of the RFID device 100 and controls logic switching in order to minimize instantaneous power consumption of the RFID device 100. A power management logic module (not shown) in the digital block 118 is responsible to power up only the necessary blocks for each stage for operations. The digital block 118 also performs and/or processes anti-collision logic, command control and interpretation, Manchester coding-decoding and memory control logic.

The digital block 118 is connected to the dc-dc converter 112 for performing power management by controlling via a control signal nR_W, the on/off switching of the dc-dc convener 112 and voltage level of the higher voltage Vdd-h. The digital block 118 is also connected to the modem 116 for processing downlink and uplink data2bb and data2rf, respectively, and controlling via a control signal Cont_mod, the on/off switching of the modem 116, and the logic translator 114 for reading from and writing to the memory 110. The digital block 118 is further connected to a clock generator 122 for controlling via a control signal Cont_clk, the generation of different clocks with different frequencies.

Other circuit blocks in the RFID device 100 include a power-on-reset circuit 120 that generates reset pulses for the digital block 118 and the clock generator 122 under a wide range of voltage supply conditions, and a low-power current reference 124 that generates bias current in nA for the digital block 118 and clock generator 122. The RFID device 100 also includes the clock generator 122, which is a programmable low-power oscillator that generates MHz clocks f₁, f₂, and f₃, for the digital block 118, the memory 110 through the logic translator 114, and the dc-dc converter 112, respectively. During communication with the RFID device reader and the RFID device 100 accesses the memory 110 in read operations, the same clock frequency is supplied to the digital block 118 and dc-dc converter 112, ie f₃=f₁, and no clock is required by the memory 110, ie f₂=0. During memory write operations, the same clock frequency is supplied to the digital block 112 and memory 110, ie f₂=f₁, while a clock frequency at a fraction, for example quarter, of f₁ is supplied to dc-dc converter 112, ie f₃=f₁/4. With this scheme, only one oscillator is required in the clock generator 122 for generating f₁ while other clock frequencies are dependent on f₁ and as a result the various circuit blocks are supplied with different clock frequencies during different situations such as the read and write operations performed on the memory 110.

With the programmable dc-dc converter 112 and logic translator 114, the RFID device 100 is able to minimize power consumption while ensuring proper logic level between various circuit blocks operating under different operating voltage supplies. With the programmable clock generator 122, the RFID device 100 is able to minimize power consumption and reduce component count while satisfying different clock requirements of different circuit blocks in the RFID device 100.

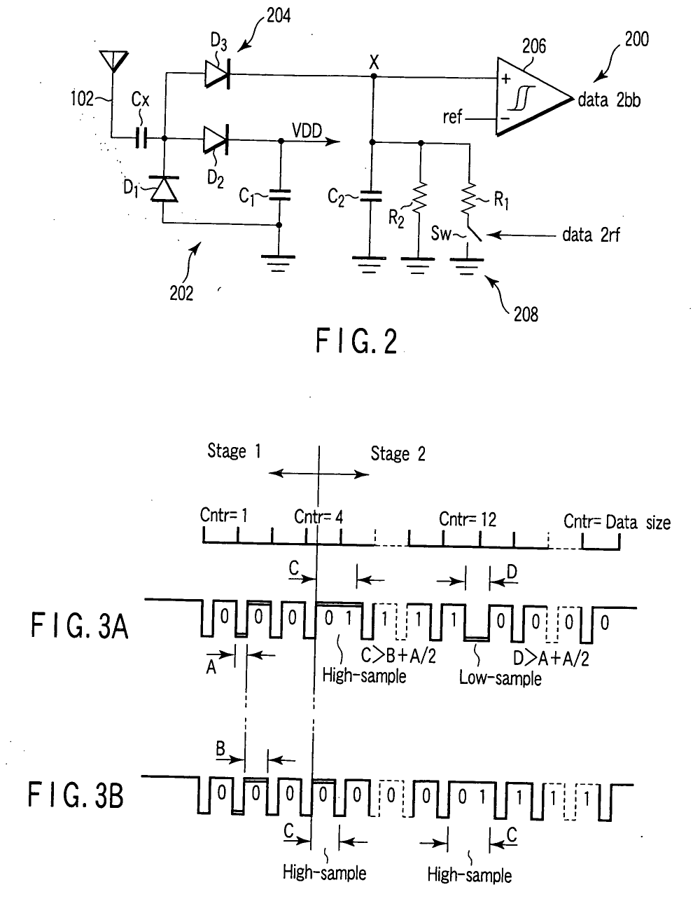

As shown in FIG. 2, an RF front end in the RFID device 100 consists of three major components, namely the rectifier 104, a demodulator 204 and a modulator 208. The demodulator 204 and modulator 208 forms the modem 116 and the rectifier 104 is implemented as a rectifying device 202, which serves as a virtual battery to power up the RFID device 100 by rectifying the downlink signal. The demodulator 204 detects the envelope of an OOK modulated downlink signal for processing by baseband circuit blocks such as the digital block 118. The modulator 208 modulates uplink CW waves by using the backscattering method.

A conventional voltage doubler is adopted as a rectifier core of the rectifying device 202, consisting of diodes D1 and D2 where the cathode of D1 is connected to the anode of D2 for providing the voltage doubler is employed as the rectifier core of the rectifying device 202.

The downlink signal is provided to the rectifying device 202 through a capacitor Cx at the inter-connection between D1 and D2 and a bypass-capacitor C1 is connected to the output of the rectifier core to smooth out the voltage at the output to provide the operating voltage Vdd.

The demodulator 204 is constructed by connecting the anode of a diode D3 to the inter-connection between D1 and D2 thereby allowing the demodulator 204 to tap the downlink signal for detection. With proper selection of resistor R₂ and capacitor C₂ connected to the cathode of D3, R₂ and C₂ being in parallel, an RC time constant of the demodulator 204 is selected such that the demodulator 204 filters out the incoming RF carrier but traces the envelope of the OOK-based downlink signal. R2 may be replaced with a current source (not shown) to drain the current at the inter-connection between D3 and R₂ and C₂. The current source is switched off to save current drawn at idling time.

According to the embodiment, all diodes are implemented using MOS devices configured as diodes.

The detected baseband signal is further converted into binary levels by a low-frequency comparator 206 with built-in hysteresis. An input terminal of the comparator 206 is connected to a reference voltage, ref (=Vdd/2, for example), which can be generated with a resistor divider and another input terminal of the comparator 206 is connected to the cathode of D3. A binary coded signal is obtained at an output terminal of the comparator 206, which is provided as data signal data2bb.

The modulator 208 consists of resistor R1 and a switch Sw through which data2rf to be transmitted to the RFID device reader in uplink signals is delivered, the switch Sw being connected in series with R1 and the free end of the R1 being connected to the cathode of D3. Backscattering is achieved by switching on/off of additional DC loading at R₁.

An off-chip printed dipole antenna is designed and used as the antenna 102 to match to the composite input impedance of the RF front end.

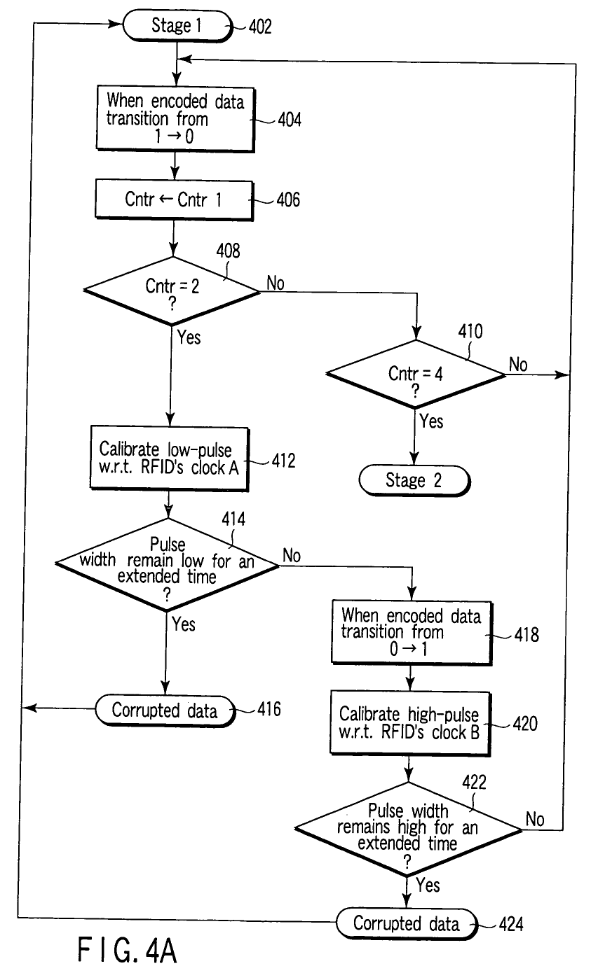

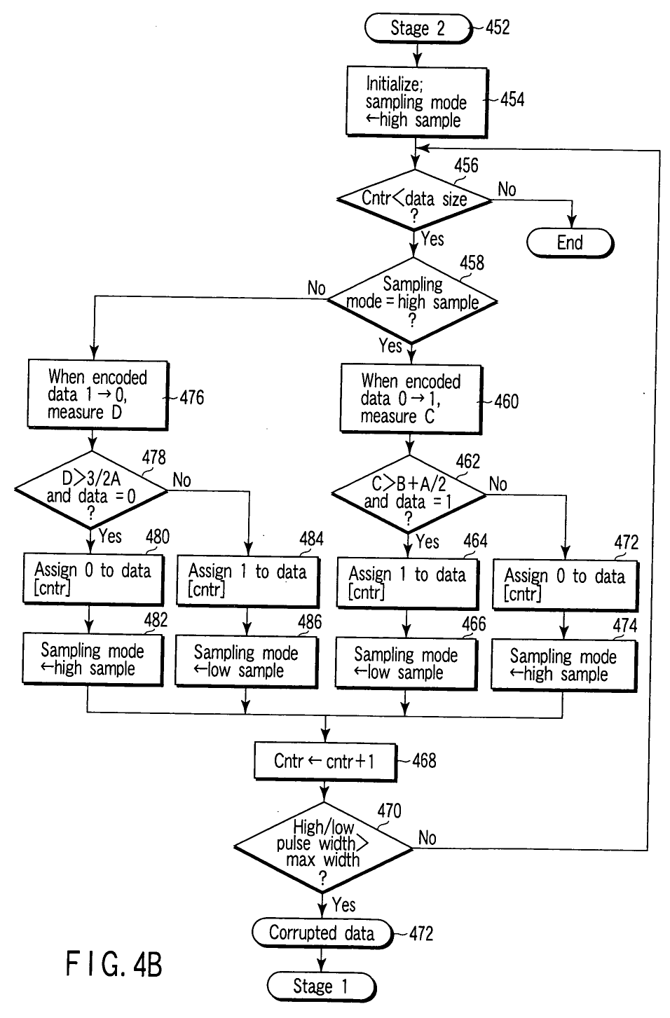

With reference to FIGS. 3A, 3B, 4A and 4B, the Manchester decoding scheme implemented in the digital block 118 is described hereinafter.

There are currently numerous conventional Manchester decoding schemes. Some of these conventional schemes involve the use of clock recovery circuits for synchronizing input data and clock. With the Manchester decoding scheme, hereinafter referred to simply as the decoding scheme, data may be decoded without a clock recovery circuit or signal-edge detection means.

The decoding scheme comprises of a two-stage process, i.e. stage 1 for pulse-width synchronization and stage 2 for data decoding as shown in FIGS. 3A and 3B, which are timing diagrams depicting examples of encoded data, and FIGS. 4A and 4B, which are flowcharts exemplifying an implementation of stages 1 and 2, respectively.

In Stage 1, synchronization bits in the encoded data are detected for providing references for low-pulse and high-pulse widths. In Stage 2, such references are then used for decoding data bits in the encoded data to obtain decoded data, hereinafter being referred to as Data [0 . . . (DataSize-1)]. The DataSize value reflects the number of data bits in the decoded data, out of which the first four bits are used as synchronization bits in the example.

In Stage 1, which is shown in FIG. 4A and begins with a step 402 in which a sequence of data stream in data2bb is processed, when encoded data in data2bb is detected to transition from 1 to 0 in a step 404, a counter Cntr, which is initialized to 0, is incremented in a next step 406. Thereafter in a step 408 the counter value Cntr is compared with the integer value 2, where if there is a mismatch the counter value Cntr is again compared with the integer value 4 in a step 410. If there is a match in the step 410 Stage 1 ends and Stage 2 begins and if there is a mismatch the process loops back to the step 404.

In the example the integer value of 4 is used in the step 410 because the number of synchronization bits are set at 4. Also the integer value of 2 is used in the step 408 because it is intended that low-pulse and high-pulse widths if the second synchronization bit is measured for providing the references.

If there is a match in the step 408, the process enters a step 412 where the low-pulse width A of the second synchronization bit, as shown in FIG. 3A, is measured with respect to the system or internal clock of the RFID device 100. In a next step 414 the measured pulse width is checked whether it remains low for an extended time as predefined in Max Width, which consists of maximum values, in which if it is true the measurement is regarded as corrupted and discarded in a step 416, after which the process then loops back to the step 402 in which a next sequence of data steam in data2bb is processed.

If it is false in the step 414, i.e., if the measured pulse width does not remain low for an extended time, the process enters a step 418 in which the encoded data in data2bb is detected to transition from 0 to 1 the high-pulse width B of the second synchronization bit, as shown in FIG. 3B, is measured with respect to the clock of the RFID device 100 in a next step 420. This measurement is then checked in a step 422 and if the measured pulse width remains high for an extended time as predefined in Max Width it is discarded in a step 424, after which the process looks back to the step 402 for processing the next sequence of data stream in data2bb. Otherwise the process loops back to the step 404.

In Stage 2, which is shown in FIG. 4B and begins with a step 452, initialization for Stage 2 occurs in a step 454 in which the decoded data Data [0 . . . (DataSize-1)] is set to the value 0 and a variable Sampling Mode is set to High Sample. DataSize is indicative of the number of bits in the decoded data. When the Sampling Mode is set to High Sample the process measures the high-pulse width of the encoded data bits and when the Sampling Mode is set to Low Sample the process measures the low-pulse width of the encoded data bits.

In a step 456, the counter value Cntr is compared with DataSize, and if the counter value Cntr is lower the process enters a next step 458. Otherwise the process ends.

In the step 458 Sampling Mode is checked if it is set to High Sample, and if there is a match the process in a step 460 measures the current high-pulse width C, which includes the high-pulse width of the current encoded data bit, starting at the low-to-high transition of the current encoded data bit and ending at the next high-to-low transition. This measurement is then compared with (B+(A/2)) in a step 462 and if C is greater than (B+(A/2)), the current encoded data bit is assigned a “1” in a step 464 and as shown in FIGS. 3A and 3B. Then in a next step 466 Sampling Mode is set to Low Sample, following which the counter is incremented in a step 468. The measurement is next tested against the respective maximum value in Max Width in a step 470, which when exceeded by the measurement it is discarded in a step 472, after which the process looks back to the step 402 for processing the next sequence of data stream in data2bb. If the maximum values are not exceeded the process loops back to the step 456.

If in the step 462 C is not greater than (B+(A/2)) the current encoded data bit is assigned a “0” in a step 472 and in a next step 468 Sampling Mode is set to High Sample. The process from thence continues with the counter increment step 468.

If in the step 458 there is no match in a step 476, the process measures the current low-pulse width D, which includes the low-pulse width of the current encoded data bit, starting at the high-to-low transition of the current encoded data bit and ending at the next low-to-high transition. This measurement is then compared with (A+(A/2)) in a step 478 and if D is greater than (A+(A/2)), the current encoded data bit is assigned a “0” in a step 480, and as shown in FIGS. 3A and 3B. Then in a next step 482 Sampling Mode is set to High Sample, following which the counter is incremented in the step 468. The measurement is next tested against the respective maximum value in Max Width in the step 470, which when exceeded by the measurement it is discarded in the step 472, after which the process looks back to the step 402 for processing the next sequence of data stream in data2bb. If the respective maximum value is not exceeded the process loops back to the step 456.

If in the step 478 D is not greater than (A+(A/2)) the current encoded data bit is assigned a “1” in a step 484 and in a next step 486 Sampling Mode is set to Low Sample. The process from thence continues with the counter increment step 468.

In the decoding scheme Stage 2 of the process performs decoding via a forward deduction technique which involves the measurement of either a low-pulse or high-pulse width starting at the transition of a current encoded data bit, therefore measuring at least the second-half of the bit interval of the current encoded data bit, for determining the next encoded data bit value using references of both low- and high-pulse widths measured during Stage 1.

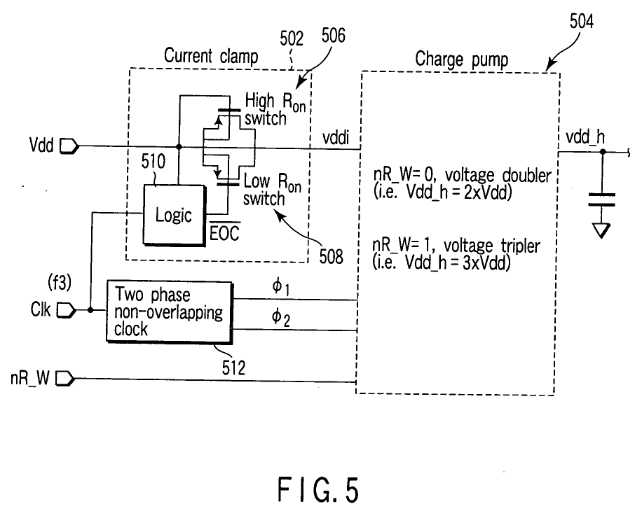

The dc-dc converter 112 is described in further details with reference to FIG. 5 for providing a method to prevent transient current surge in the RFID device 100. As critical as it is for passive devices such as the RFID device 100 to perform low-power operations, it is also unacceptable if circuit blocks in the RFID device 100 consume large dynamic currents even though the overall average current consumed is low. This usually occurs when circuit blocks are turned-on during power-on and huge surge currents are used to charge internal nodes within these circuit blocks.

In power management concepts, which usually involve turning on/off circuit blocks during actual operation to save power, this can be the factor that causes the device to malfunction because of large voltage supply dip.

The dc-dc converter 112 consists of a current-clamp circuitry 502 and a charge-pump circuit 504. The current-clamp circuitry 502 is placed between the output of the rectifier 104 to accept the rectified voltage (Vdd) and the charge-pump circuit 504. The current-clamp circuitry 502 serves to control current flow during the operation of the charge-pump circuit 504.

As shown in FIG. 5, the current-clamp circuitry 502 employs two PMOS switches having their output terminals inter-connected, one PMOS being high on-resistance (Rₒₙ) 506 and another PMOS being of low Rₒₙ 508. These switches are controlled by a logic module 510 and are switched off/on accordingly. When the memory 110 is not accessed, both these switches are turned off.

The logic module 510 performs switching so that when the current clamp circuitry 502 starts operating, only the high-Rₒₙ PMOS 506 is tuned on. This limits the amount of current that can be drawn from the rectifier 104. There is an internal counter (not shown) in the logic module 510 that starts counting for 32 clock cycles, after which the low-Rₒₙ PMOS 506 is turned on for normal operation (EOC=1).

The advantages of RFID device 100 are manifold. The advantages associated with the RF front end are as follows:

(i) The RF Front End is implemented using a low-cost standard CMOS process, which is compatible with the mainstream technology for baseband circuitries, and allows a fully integrated solution in single silicon chip. In conventional proposals, the RF front end is constructed from high performance external Schottky diodes and the baseband circuit is implemented in CMOS process. While Schottky diodes offer the best RF performance, these devices are not available in standard CMOS process. The hybrid approach suffers from high cost with bulky structure, which offsets the added value inherent in RFID technology and prevents RFID from mass scale deployment.

(ii) Reduced cost and form factor by eliminating external components and the associated assembly expense.

(iii) More reliable performance because: 1) IC technology provides better device matching than discrete devices. 2) Avoid assembly misalignment of critical RF parts.

(iv) Potential for integrating on-chip antenna to form a total RFID solution.

The advantages associated with the current clamp circuitry 502 are as follows:

(i) Current clamping allows proper power management to be applied to these modules without worrying for high surge current during re-powering.

(ii) Additional circuit is small, mainly two switches and some flip-flops (digital is small in current technology)

(iii) No current is consumed from the logic block during normal operation (pure digital), as such no additional wastage of power

(iv) Additional circuit acts as a clean supply cut off from the charge-pump when not in use.

In the foregoing manner, a low-power, passive RFID device having different operating voltage supplies and clock frequencies for performing power-saving operations is disclosed. Although only a number of embodiments of the invention are disclosed, it becomes apparent to one skilled in the art in view of this disclosure that numerous changes and/or modification can be made without departing from the scope and spirit of the invention. For example the Manchester decoding scheme is applicable to all ranges of incoming data duty cycle. Also in the current clamping circuitry, the digital counter value is a variable depending on implementation. The digital logic can be implemented in many other ways, as long as the delay is achieved to turn on the strong transistor, ie the low-Rₒₙ PMOS.

What is claimed is:

1. A radio frequency identification and communication device communicable with a device reader, comprising:
an RF front end which receives from and transmits to the device reader RF signals and extracts power and data from a received RF signal;
a controller which receives the RF signal from the RF front processor, measures a low-pulse width “A” and a high-pulse width “B” of synchronization bits of the received RF signal, measures a low-pulse width “C” and a high-pulse width “D” of encoded data bits of the received RF signal, and decodes the encoded data bits by using the measured pulse widths “C” and “D” and transmits to the decoding result to the RF front end; and
a memory which receives from and transmits to the controller data wherein the memory is readable and writable by the controller and operable using first and second voltage supplies during read and write operations, respectively, the first and second voltage supplies being of different voltage supply levels.

2. The device as in claim 1, wherein the RF front end conveys an extracted power from the received RF signal to a supply converter which provides the first and second voltage supplies.

3. The device as in claim 2, wherein the supply converter comprises a charge-pump which provides first and second voltage.

4. The device as in claim 3, wherein the supply converter comprises a current clamp which limits current flow from the RF front end to the charge-pump.

5. The device as in claim 4, wherein the current clamp is controllable to disconnect the current flow from the RF front end to the charge-pump when the memory is not performing read and write operations.

6. The device as in claim 3, wherein the charge-pump is controllable to provide the first and second voltage supplies.

7. The device as in claim 1, wherein the voltage supply level of the second voltage supply is greater than the voltage supply level of the first voltage supply.

8. The device as in claim 1, further comprising a logic translator to translate data readable and writable by the controller to data having logic levels for receiving from and transmitting to, respectively, the memory.

9. The device as in claim 8, wherein the logic translator is operable using the first and second voltage supplies.

10. The device as in claim 1, wherein the RF front end comprises:
a rectifier which extracts power from the received RF signal;
a demodulator which detects an envelop of the received RF signal; and
a modulator for modulating a baseband signal generated by the controller in response to the received RF signal for transmitting to the device reader.

11. The device as in claim 10, wherein the rectifier is implemented using MOS devices.

12. The device as in claim 1, wherein the controller performs the decoding process using a forward deduction technique.

13. The device as in claim 12, wherein the controller measures the pulse widths for identifying a reference low-pulse width and a reference high-pulse width using counts.

14. The device as in claim 13, wherein the controller measures the pulse widths for identifying one of a low-pulse width and a high-pulse width in a current count.

15. The device as in claim 14, wherein the controller compares the identified one of a low-pulse width and a high-pulse width with the reference low-pulse width and the reference high-pulse width for determining a “1” or “0” in a next count.

16. The device as in claim 1, further comprising a clock generator which is programmable for providing a plurality of clock frequencies.

17. The device as in claim 16, wherein the memory is readable and writable by the controller and operable using first and second clock frequencies of the plurality of clock frequencies provided by the clock generator during read and write operations, respectively, the first and second clock frequencies being different.
